(19) United States
(12) Patent Application Publication
(10) Pub. No.: US 2019/0287113 A1
(43) Pub. Date: Sep. 19, 2019

(54) CUSTOMIZED SCORE-BASED BASKET APPROVAL SYSTEM

(71) Applicant: Walmart Apollo, LLC, Bentonville, AR (US)

(72) Inventors: Cameron Wright, Rogers, AR (US); Mahesh Mellempuri, Centerton, AR (US)

(21) Appl. No.: 16/266,109

(22) Filed: Feb. 3, 2019

Related U.S. Application Data
(60) Provisional application No. 62/642,308, filed on Mar. 13, 2018.

(51) Int. Cl. G06Q 20/40; G06K 7/14; G06Q 20/20; G06Q 20/18

(52) U.S. Cl. CPC G06Q 20/4016; G06K 7/1413; G06Q 20/18; G06Q 20/208; G06K 7/1417

(57) ABSTRACT

Examples provide a system for score-based verification of basket contents. A user trust score is generated based on the user's transaction history, item selection area data, and trust rules. The trust score provides a base value which is decremented by a predetermined amount based on behavior-related triggers detected as the user scans items during item selection to generate a temporary per-basket verification score. The triggers include a threshold number of item voids, a threshold number of unknown items scanned, and/or a threshold time elapsed after scanning an item. If the per-basket verification score is greater than or equal to a minimum threshold score, the basket is approved for check-out. If the per-basket verification score is below the threshold value, the basket of items is selected for a partial verification of the contents of the basket. If the partial verification fails, a comprehensive verification of the basket contents is initiated.

Self-checkout systems typically enable customers to self-scan items for purchase via an unmanned or automated mechanism. Self-checkout can also be referred to as automated check-out or self-service checkout. Self-checkout typically involves users scanning items and then providing payment via a self-checkout payment device once the user indicates that scanning of all items in a basket or cart is complete. However, users may fail to accurately scan all items in their basket due to user error, mistake, and/or missing or unreadable barcodes on the item. Likewise, users can accidently scan a single item multiple times. Some systems attempt to minimize inaccurate item scanning in self-checkout by utilizing scales to weigh items as they are scanned and/or placed in a bagging area during self-checkout. The weights of scanned items are compared to known/expected weights of the items. However, weighing items can be a time-consuming and potentially inaccurate process. If item weight data is inaccurate, the system typically interrupts the self-check process which causes delay and frustration for users, as well as additional personnel to assist users unfamiliar with the process.

### SUMMARY

Some examples provide a system for customized trust-based basket verification. The system includes a memory; at least one processor communicatively coupled to the memory; and a first scan device generating first scan data associated with a set of items in a plurality of items within an item selection area. A basket score generator decrements a per-user trust score associated with the first user in accordance with a set of scoring criteria and a set of triggers within the first scan data. The basket score generator generates a per-basket verification score associated with a basket of items selected by the first user in response to the first user reaching a basket completion checkpoint within the item selection area. The first scan data identifies at least one item in the set of scanned items. The set of scoring criteria includes a predetermined score decrement value applied to the per-user trust score in response to occurrence of at least one trigger. If the per-basket verification score is within an acceptable score threshold range, a basket approval component approves the basket of items without a partial verification of contents of the basket. A verification component compares the first scan data with second scan data obtained from a second scan device associated with the partial verification of the contents of the basket. If the second scan data corresponds to at least a portion of the first scan data, the verification component approves the basket of items without comprehensive verification of the entire contents of the basket. The second scan data includes data identifying a threshold number of items from the basket of items. If an item identified in the second scan data fails to correspond to an item identified in the first scan data, a notification component outputs a basket re-check notification requesting comprehensive verification of the entire contents of the basket.

Other examples provide a computer-implemented method for customized trust-based basket verification. A score generation component generates a trust score for a selected user based on transaction history data associated with the selected user and a store trust level associated with an item selection area. A basket monitor component analyzes first scan data obtained from a first scan device associated with the selected user. The first scan data is analyzed using a set of trust rules to identify a set of triggers. The set of triggers includes a set of unknown scanned items associated with the first scan data. A temporary score generator generates a per-basket verification score based on the per-user trust score, the set of triggers, and a set of scoring criteria. If the set of triggers is a null set or the per-basket verification score is within an acceptable score threshold range, a basket approval component approves the basket without verification of the contents of the basket. The basket includes one or more items selected by the user from a plurality of items by the selected user without verification of the contents of the basket. A verification component approves the basket without verification of the entire contents of the basket if a subset of the items in the basket identified by second scan data obtained from a second scan device corresponds to at least one item identified by the first scan data. The second scan data includes data identifying a threshold number of items from the basket. If at least one item identified in the second scan data fails to correspond to any item identified in the first scan data, the verification component rejects the basket of items.

Still other examples provide a system for customized score-based verification of the contents of a basket. The system includes a memory and at least one processor communicatively coupled to the memory. A first scan device associated with a first user within an item selection area. The item selection area includes a items. A basket monitor component analyzes first scan data obtained from the first scan device using a set of trust rules upon arrival of the first user at a basket completion checkpoint. The basket monitor component identifies a set of triggers based on the analysis. A trigger includes at least one of a threshold number of voided items, a threshold number of unknown items scanned, or a threshold idle time between scanning items associated with the first scan data. A basket approval component approves a basket of items selected from the plurality of items by the first user without verification of contents of the basket if the set of triggers associated with the first scan data is a null set. If the set of triggers includes at least one trigger, a basket score generator generates a per-basket verification score based on the first scan data and a set of scoring criteria. The set of scoring criteria includes a predetermined score decrement value applied to the per-user trust score in response to occurrence of at least one trigger. If the per-basket verification score is within an acceptable score threshold range, the basket approval component approves the basket without verification of the contents of the basket. A verification component compares the first scan data with second scan data obtained from a second scan device associated with a second user verifying a subset of items from the basket. If the second scan data corresponds to at least a portion of the first scan data, the verification component approves the basket without a comprehensive verification of every item in the basket. The second scan data includes data identifying a subset of items selected from the basket of items by the second user having an aggregate value within a threshold range.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for score-based basket verification.

FIG. 2 is an exemplary block diagram illustrating an item selection area.

FIG. 3 is an exemplary block diagram illustrating a system for verifying basket contents.

FIG. 4 is an exemplary block diagram illustrating a system for score-based basket verification.

FIG. 5 is an exemplary block diagram illustrating a self-check manager component.

FIG. 6 is an exemplary block diagram illustrating a verification component.

FIG. 7 is an exemplary block diagram illustrating a database.

FIG. 8 is an exemplary block diagram illustrating a system for score-based self-check basket auditing.

FIG. 9 is an exemplary block diagram illustrating an audit configuration file.

FIG. 10 is an exemplary block diagram illustrating a range of per-basket verification scores.

FIG. 11 is an exemplary flow chart illustrating operation of the computing device to verify contents of a basket based on first scan data and second scan data.

FIG. 12 is an exemplary flow chart illustrating operation of the computing device to verify partial contents of a basket.

FIG. 13 is an exemplary flow chart illustrating operation of the computing device to approve a basket without verification of basket contents.

FIG. 14 is an exemplary flow chart illustrating operation of the computing device to verify items in a basket based on basket scores.

FIG. 15 is an exemplary flow chart illustrating operation of the computing device to calculate a per-basket verification score.

Corresponding reference characters indicate corresponding parts throughout the drawings.

### DETAILED DESCRIPTION

Referring to the figures, examples of the disclosure enable score-based approval of basket contents for self-checkout. In some examples, a self-check manager assigns a trust score to each user performing a self-check associated with a basket of items. The trust score is generated based on a user-created profile, the user's transaction history, including history of previous self-check transactions. The trust score enables more efficient and accurate determination of the user's experience and relative trustworthiness associated with performing self-checkout of items.

In other examples, the self-check manager generates a per-basket verification score based on the user's trust score and the user's behavior while selecting items for purchase via the self-check system. If the per-basket verification score is within an acceptable score threshold range, the user is authorized to complete self-checkout without a verification of the contents of the user's basket. The per-basket verification score improves self-checkout verification speed while reducing the number of incorrectly scanned items and/or un-scanned items in the user's basket at transaction completion while improving user efficiency via the automated self-check system.

In other examples, the system generates a per-basket verification score for determining whether to permit self-check of items in a selected user's basket with convenience for users while providing asset protection. Each time the user utilizes the system to obtain items via self-check, the system assigns a new, unique per-basket verification score. In other words, the per-basket verification score is different each time the user utilizes the self-check system. The per-basket verification score enables the system to more accurately determine whether partial verification of a user's basket contents should be performed based on the user's real-time behavior during item selection and scanning. This enables decreased loss of merchandise, prevents inventory shrinkage and improves user experience by permitting some users to self-check without verification of their basket contents based on their unique score.

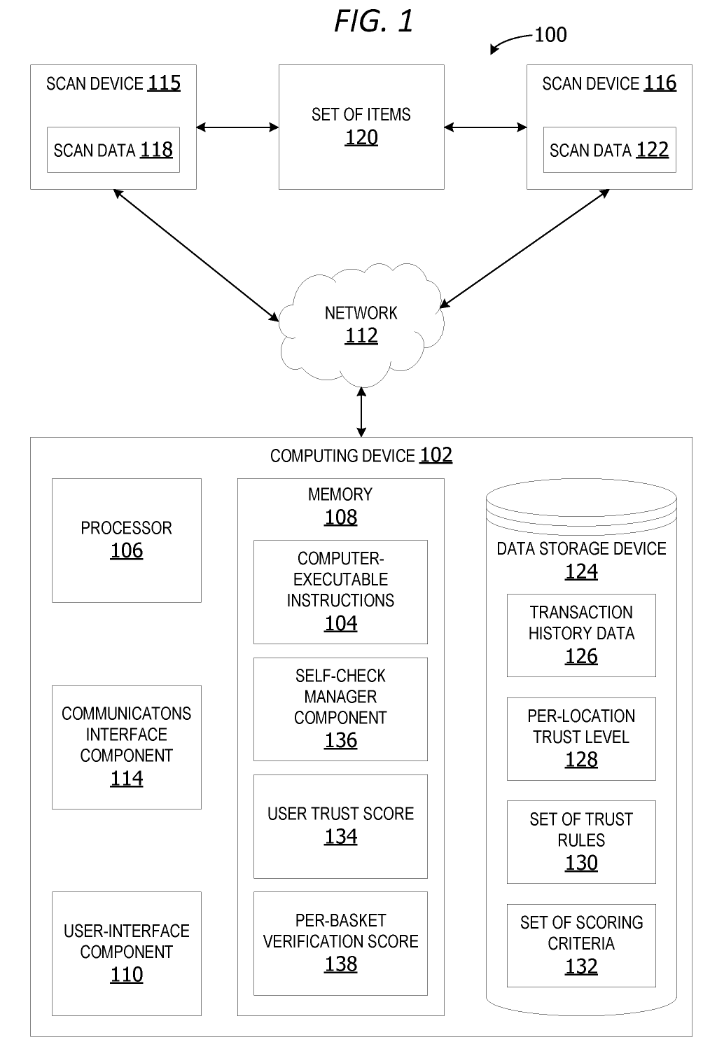

Referring again to FIG. 1, an exemplary block diagram illustrates a system 100 for score-based basket verification. In the example of FIG. 1, the computing device 102 represents any device executing computer-executable instructions 104 (e.g., as application programs, operating system functionality, or both) to implement the operations and functionality associated with the computing device 102. The computing device 102 can include a mobile computing device or any other portable device. In some examples, the mobile computing device includes a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 can also optionally include a user interface component 110.

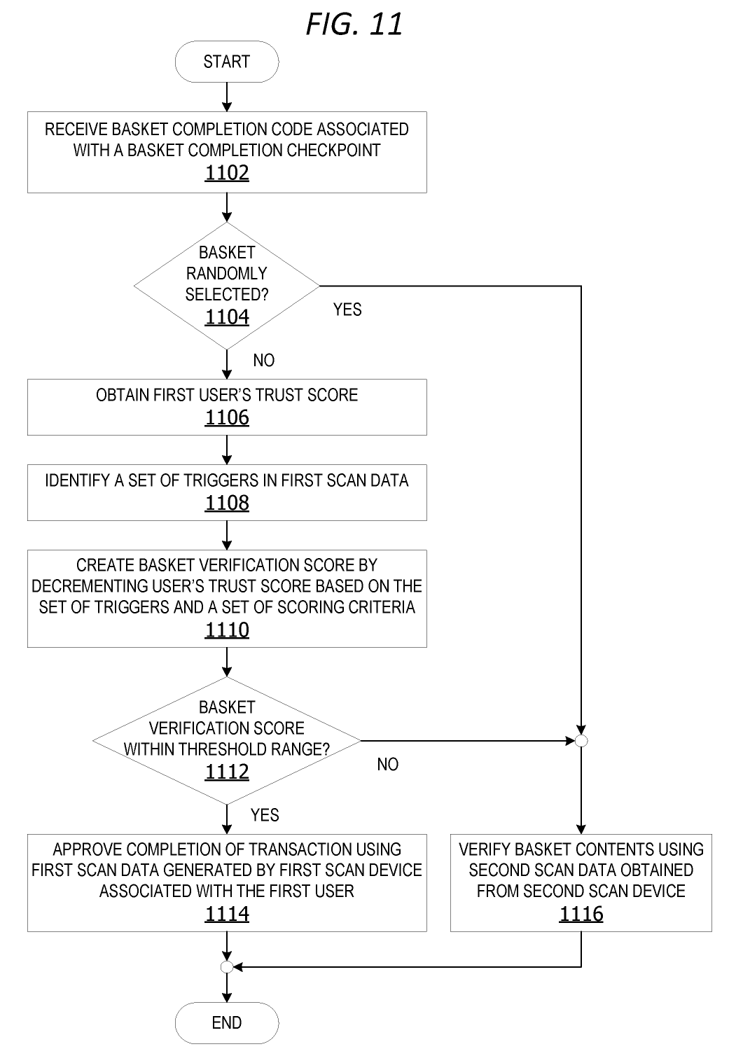

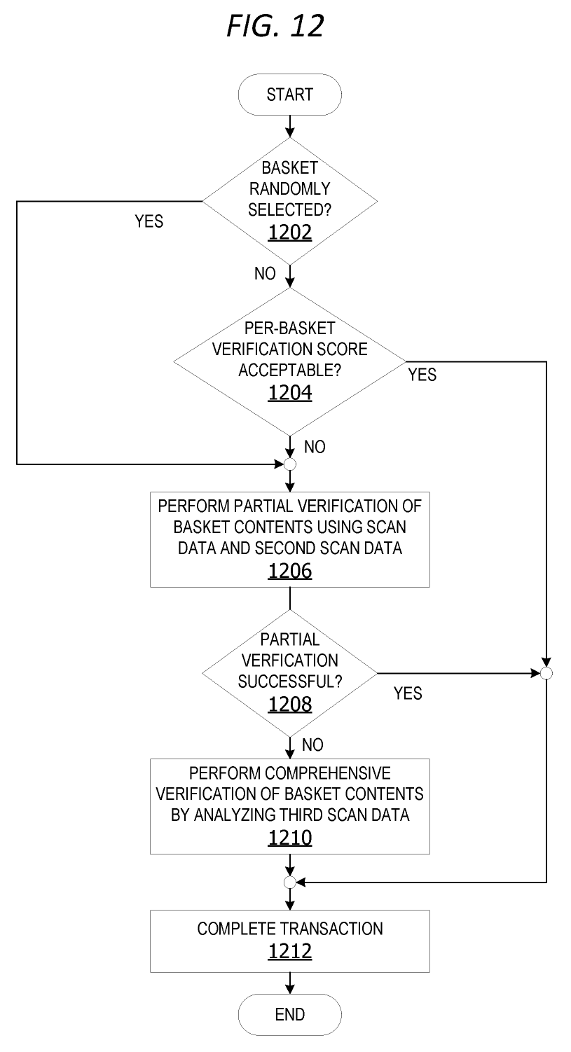

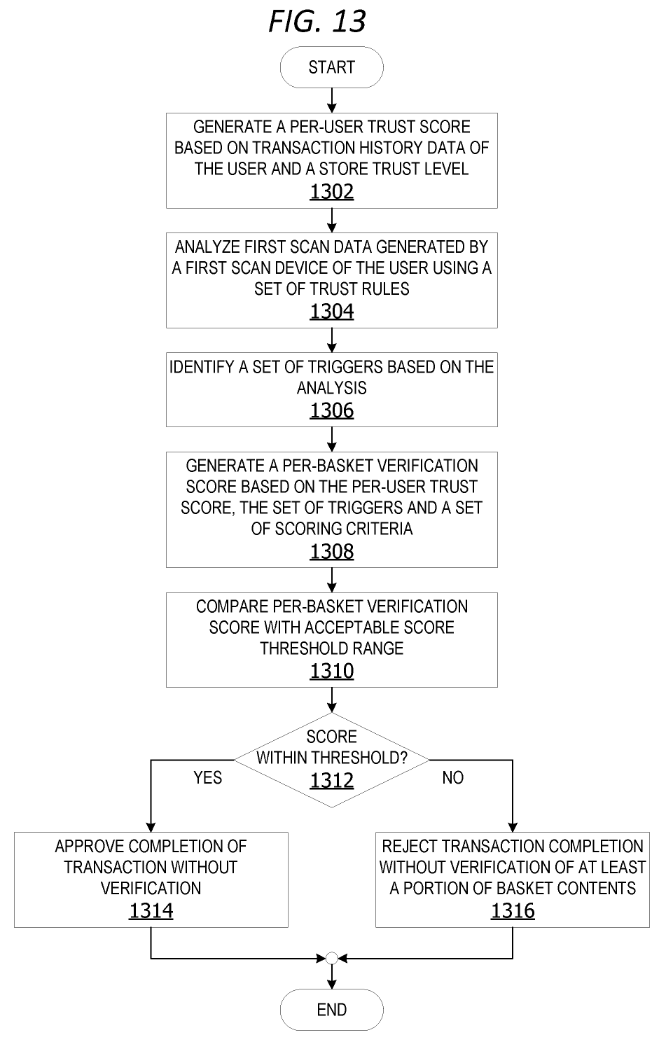

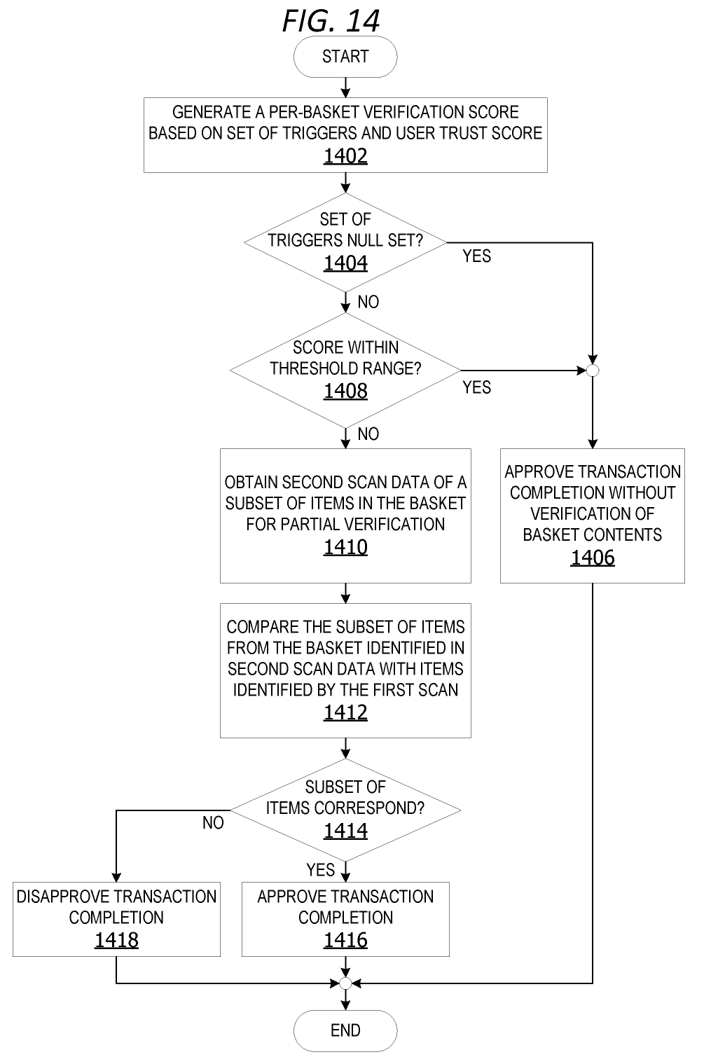

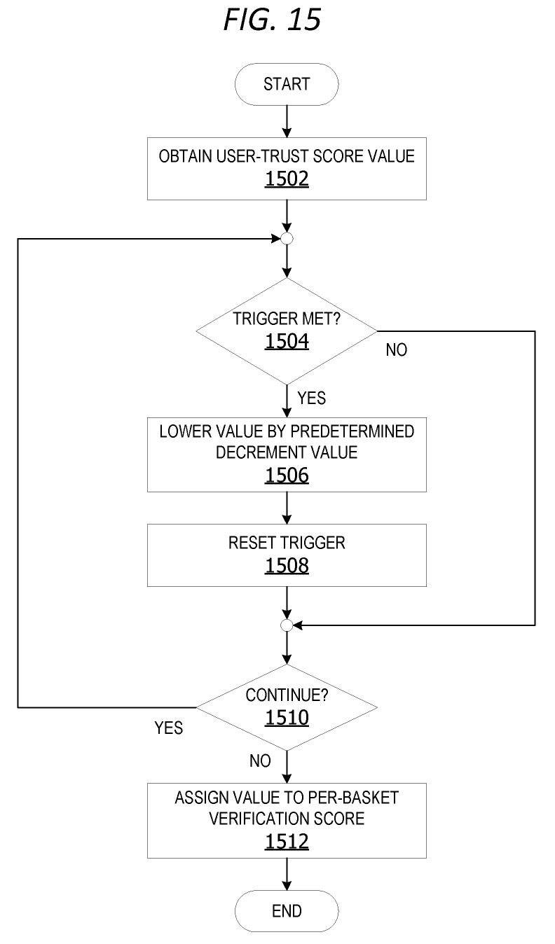

The processor 106 includes any quantity of processing units and is programmed to execute the computer-executable instructions 104. The computer-executable instructions 104 can be performed by the processor 106 or by multiple processors within the computing device 102 or performed by a processor external to the computing device 102. In some examples, the processor 106 is programmed to execute instructions such as those illustrated in the figures (e.g., FIG. 11, FIG. 12, FIG. 13, FIG. 14 and FIG. 15).

The computing device 102 further has one or more computer readable media such as the memory 108. The memory 108 includes any quantity of media associated with or accessible by the computing device 102. The memory 108 can be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. For example, the applications can represent downloaded client-side applications that correspond to server-side services executing in a cloud, such as on a cloud server.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. For example, the user can input commands or manipulate data by moving the computing device 102 in a particular way.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to sensor devices, such as the scan device 115 and the scan device 116, can occur using any protocol or mechanism over any wired or wireless connection. In some examples, the communications interface component 114 is operable with short range communication technologies such as by using near-field communication (NFC) tags.

The scan device 115 is a scan device for generating scan data 118 associated with one or more items in a set of items 120 in a user's basket. The scan device 116 in other examples is a second scan device for generating scan data 122 associated with the set of items 120 in the user's basket.

The scan device 115 and 116 can be implemented as a universal product code (UPC) scanner, a matrix barcode scanner, a quick response (QR) code reader, a radio frequency identifier (RFID) code, or any other type barcode reader. The scan device 115 in this example is a first scan device utilized by a user (customer) to scan items as the user shops within an item selection area. In some examples, the user scans each item in the set of items 120 as the user picks up/selects the item and/or prior to placing the item in the user's physical basket or scanning the item into the user's electronic basket.

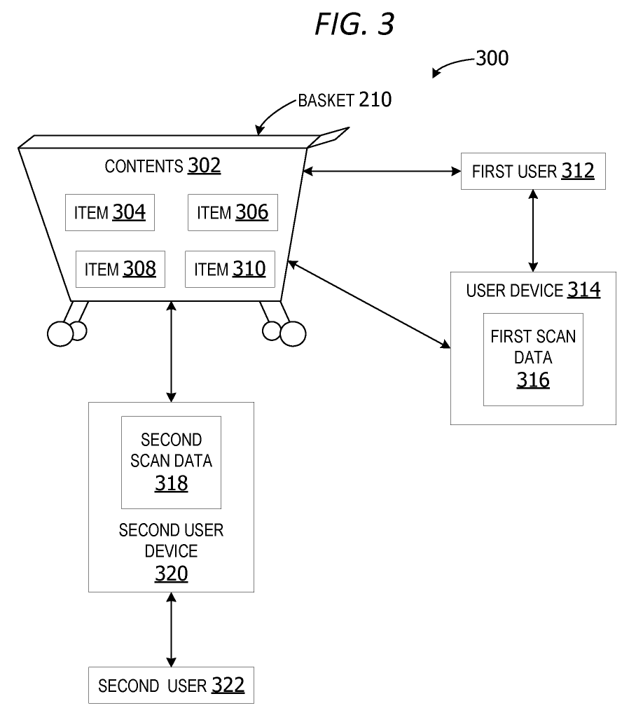

The scan device 115 in some non-limiting examples is a hand-held scan device provided by the item selection area. In other examples, the scan device 115 is included within a user device, such as the user device 314 in FIG. 3 below. In these examples, the scan device 115 is implemented within a user device, such as, but not limited to, a smart phone, tablet computing device, and/or wearable computing device, such as a smart watch or smart glasses.

The scan data 118 and the scan data 122 is data generated by the scan device 115 and/or the scan device 116. The scan data 118 and 122 can include RFID tag data, UPC data, matrix barcode data, QR code data or any other type of data associated with a barcode or other item identifier on an item in the set of items 120.

In some examples, the scan device 116 is a second scan device associated with a self-check basket completion checkpoint. The scan device 116 automatically scans one or more items in the set of items 120 without intervention of a human operator. The scan device 116 can be mounted on a ceiling, a side of a self-checkout area, or other area. In other examples, the scan device 116 is a robotic scan device capable of autonomously scanning items. In still another example, the scan device 116 can include a hand-held scan device or a scan device mounted to a ceiling, pole, table, or other surface. The scan device is utilized by a second user for scanning one or more items in the set of items 120.

The system 100 can optionally include a data storage device 124 for storing data, such as, but not limited to transaction history data 126 associated with each user, per-location trust level 128 associated with an item selection area, a set of trust rules 130 and/or a set of scoring criteria 132. The transaction history data 126 can include a history of previous item purchases and/or item returns by a given user. The transaction history data 126 can include the data, time and/or location of each transaction, the number of items involved, and/or the value of each item purchased or returned.

The per-location trust level 128 is a trust rating for each item selection area. The per-location trust level 128 is customized for each item selection area. A higher per-location trust level 128 can indicate greater trust afforded to self-checkout users and/or a lower incident of error associated with self-checkouts at the location. The per-location trust level 128 can be generated based local factors, such as demographic data, local weather, local events, seasonal data, crime-rates in the area, shrinkage at the item selection area, etc. For example, the per-location trust level 128 can be lower during time-periods in which the item selection area is more congested, rates of item shrinkage/loss are higher and/or when there are fewer personnel within the item selection area.

The set of trust rules 130 is a set of rules utilized by a self-check manager component 136 to generate a user trust score 134 for each user based on the user's transaction history data 126 and the per-location trust level 128 for the store. In some examples, the set of trust rules includes a score increment value added onto a base score value based on the number of transactions by the user, the number of years the user is a registered user/maintains a profile, the value of each transaction, number of item purchases, value of each item purchase, number of item returns, value of each item return, etc. In a non-limiting example, if the base score is ten, the trust rules indicate the score should be increased by one point for each item successfully returned in the past, increased by five points if the user has made a purchase within the last week, increased by twenty points if the user has a valid profile and/or is a registered self-check returns user, etc.

In other examples, the set of trust rules 130 include a score decrement value used to decrement the base score based on the number of failed item returns and/or time since the user last updated their profile.

The set of scoring criteria 132 is a set of rules for generating a per-basket verification score 138 for the set of items 120 in the user's basket based on the user trust score 134 and the user's behavior during selection of the set of items 120 prior to arriving at a transaction completion checkpoint. The per-basket verification score 138 is a score associated with a basket of items.

The data storage device 124 can include one or more different types of data storage devices, such as, for example, one or more rotating disks drives, one or more solid state drives (SSDs), and/or any other type of data storage device. The data storage device 124 in some non-limiting examples includes a redundant array of independent disks (RAID) array. In other examples, the data storage device 124 includes a database.

The data storage device 124 in this example is included within the computing device 102 or associated with the computing device 102. In other examples, the data storage device 124 is a remote data storage accessed by the computing device via the network 112, such as a remote data storage device, a data storage in a remote data center, or a cloud storage.

The memory 108 in some examples stores one or more computer-executable components. Exemplary components include the self-check manager component 136. The self-check manager component 136, when executed by the processor 106 of the computing device 102, the self-check manager component 136 generates the user trust score 134 for a selected user based on the user's transaction history data 126 and the per-location trust level 128 associated with an item selection area. The self-check manager component 136 analyzes the scan data 118 obtained from the scan device 115 in real-time as the user is scanning items and placing those items in the user's basket. The self-check manager component 136 analyzes the scan data as each item is scanned using the set of trust rules 130 to identify a set of triggers. The set of triggers are behavior-related triggers, such as, but not limited to, a user scanning an unknown item (unrecognized item), the user voiding/deleting a scanned item, an amount of elapsed time (idle time) between scanning items, etc. The self-check manager component 136 updates the per-basket verification score 138 in real-time based on detection of triggers as the user shops.

The basket verification score is initially set of a value equal to the user's trust score value. In other words, the user's trust score provides a “base score” for calculating the basket verification score. The user's trust score value is the initial basket verification score. The initial basket verification score is lowered/decreased by a predetermined number of points/predetermined decrement value for each trigger that is detected based on the per-user trust score and a set of scoring criteria.

The self-check manager component 136 approves completion of a self-checkout purchase of the set of items 120 without verification of contents of the basket if the set of triggers is a null set (no behavior-related triggers) or the basket verification score is within an acceptable score threshold range.

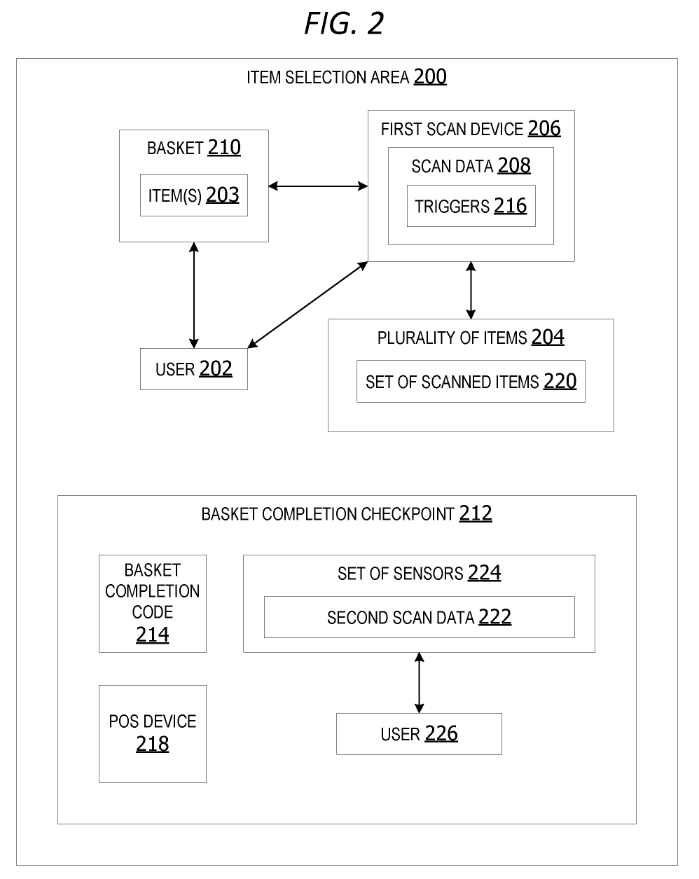

FIG. 2 is an exemplary block diagram illustrating an item selection area 200. The item selection area 200 is a store or other retail location. The item selection area 200 can include an indoor location, an outdoor location, or a combination of indoor and outdoor space. In some examples, a user 202 selects one or more item(s) 203 in a plurality of items 204 within the item selection area. The plurality of items 204 can be displayed on or in one or more item display areas within the item selection area 200, such as, but not limited to, a side-counter, end-cap display, refrigerated display, freezer display, counter, warming cabinet, gondola shelves, or any other type of display. The items in the plurality of items 204 can include any type of items, such as, but not limited to comestibles, automotive parts, pet care items, clothing items, toys, electronics, footwear, or any other type of items. Comestibles can include dairy items, produce items, can goods, frozen foods, or any other type of edible items.

The user 202 scans each item in the one or more item(s) 203 using a first scan device 206 to generate scan data 208 associated with the item(s) 203 as each item is placed in the user's basket 210. The scan data 208 can include data identifying each item, time of scanning, date of scanning, price of item, size of item, or any other data associated with the scanned item. In some examples, the basket 210 is a physical container, such as a physical basket, bag or cart for carrying or moving the item(s) 203 selected by the user.

The basket can include one or more containers, such as, but not limited to, a hand-held basket, a shopping cart on wheels, a motorized cart with a seat for the user, a cloth bag, a tote, a frame with wheels supporting a bag or any other type of container. In some examples, the basket can also optionally include a storage compartment within an unmanned ground vehicle (UAG), unmanned aerial vehicle (UAV), or a storage compartment within some other type of robotic item transport device for carrying/transporting the item(s) throughout the item selection area 200. Thus, the basket can include the items in a single item storage container, as well as items in two or more containers selected and/or purchased as part of a single transaction by the user.

In other examples, the basket 210 is an electronic basket representing the set of items scanned by the user for purchase via the self-check system. The electronic basket can be associated with the user's account. In some examples, the basket 210 refers to a group of one or more items selected by the user and scanned into the user's electronic basket. The items can be carried to a basket completion checkpoint 212 without any physical basket, cart, bag or other container. In other words, the basket 210 can refer to the item(s) 203 carried to the basket completion checkpoint 212 in the user's hands or arms without a cart, bag or basket.

The basket completion checkpoint 212 is an area where the user 202 completes a self-checkout transaction. In some examples, the user 202 scans a basket completion code 214 available at the basket completion checkpoint 212 using the first scan device 206. Scanning the basket completion code 214 triggers 216 the self-check manager component to retrieve the first scan data for utilization in performing score-based basket approval.

The basket approval component analyzes the first scan data using the set of scoring criteria to generate a per-basket verification score and determine whether to approve the basket without a partial verification of the contents of the user's basket. If the transaction completion is approved, the system utilizes data describing a set of scanned items 220 in the scan data 208 generated by the first scan device 206. The user 202 can provide payment for the set of scanned items 220 via a point of sale (POS) device 218. In other examples, the user 202 completes the transaction via a user device.

If completion of the transaction is not approved without partial verification of the basket contents based on analysis of the first scan data 208, the system obtains second scan data 222 generated by a set of one or more sensors 224 associated with the basket completion checkpoint 212. The set of sensors 224 can include a hand-held scanner utilized by a second user 226 scanning one or more of the item(s) 203. In other examples, the set of sensors 224 includes one or more mounted scanning devices, one or more image capture devices, one or more RFID tag readers, one or more robotic sensor devices or any other type of sensors for automatically gathering second scan data 222 without human assistance.

In some examples, the set of sensors 224 includes one or more image capture devices associated with a checkout area (basket completion checkpoint area). The image capture devices generate image data associated with a user's basket and/or contents of the user's basket. The image data is utilized to verify partial contents of the user's basket without human intervention. The set of sensors, in other examples, includes tunnel scanners in which the user walks the basket or cart through the tunnel area enabling the system to capture images of the basket contents from different angles for more detailed and accurate image data.

In these examples, image recognition with artificial intelligence (machine learning) is utilized to analyze the image data generated by the image capture device. Pattern analysis and image recognition is utilized with item data describing the size, shape and appearance of items, item labels and/or item packaging. Items in the user's basket are identified via this image analysis without assistance from a user.

The image recognition of items can be performed using pattern matching algorithms to identify a package shape, color, identifying marks, labels, size etc. A basket or cart has a fixed-point size/dimensions known to the system. The system utilizes the known dimensions of the cart/basket to determine size of item relative to known basket size. In some examples, image data is utilized to identify UPC codes, digital watermarks, labels, text on packaging, or other identifying markings on an item.

FIG. 3 is an exemplary block diagram illustrating a system 300 for verifying basket contents 302. The contents 302 of a basket 210 includes one or more items selected by a first user 312. The contents 302 of the basket 210 in this example includes item 304, item 306, item 308 and item 310. The basket 210 contents 302 is not limited to four items. In other examples, the contents 302 include a single item, two items, three items, as well as five or more items.

The first user 312 scans item 304 before placing item 304 in the basket 210 using a user device 314 to generate first scan data 316. The user device 314 represent any device executing computer-executable instructions. The user device 314 can be implemented as a mobile computing device, such as, but not limited to, a wearable computing device, a mobile telephone, laptop, tablet, computing pad, netbook, gaming device, and/or any other portable device. The user device 314 includes at least one processor and a memory. The user device 314 can also include a user interface component. In this example, the user device 314 includes a scanner for scanning a barcode, RFID tag, QR code, matrix barcode, or another item identifier or marker, such as, but not limited to, the scan device 115 in FIG. 1.

In some examples, if approval of the basket 210 contents 302 is not approved without partial verification of the contents 302, the system obtains second scan data 318 from a second scan device 320. The second scan device 320 can be a hand-held scan device utilized by a second user 322. In these examples, the second user 322 scans a portion of the items in the basket 210 selected randomly by the second user 322. For example, the second user 322 can scan item 304 and 310 but does not scan item 306 and 308. In another example, the second user 322 can scan item 308 but not item 304, 306 and 310 to generate the second scan data 318.

In other examples, the second scan device includes a set of automated sensors. The second scan device 320 generates the second scan data without human intervention.

The system compares the second scan data 318 with the first scan data 316 to determine if the items identified in the second scan data match the items identified in the first scan data 316. If the portion of the contents 302 of the basket 210 identified in the second scan data 318 correspond to one or more items identified in the first scan data 316, the basket contents 302 are approved via the partial verification and completion of the transaction is approved.

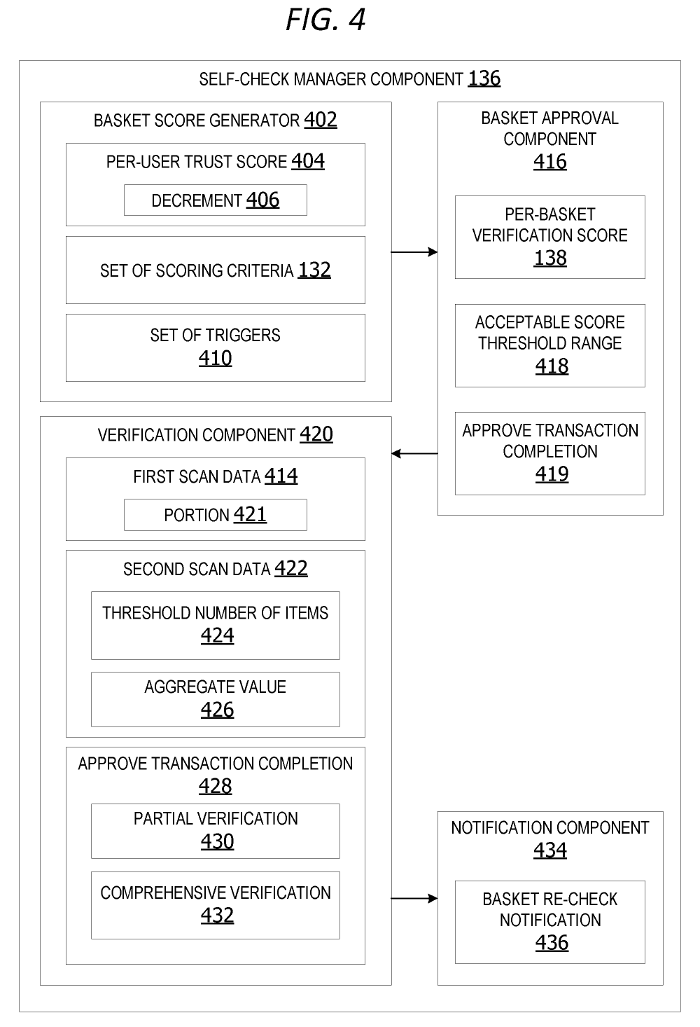

FIG. 4 is an exemplary block diagram illustrating a self-check manager component 136. The self-check manager component 136 in some examples includes a basket score generator 402. The basket score generator 402 decrements 406 a per-user trust score 404 associated with a selected user in accordance with a set of scoring criteria 132 and a set of triggers 410. The per-user trust score 404 is a trust score assigned to the selected user, such as, but not limited to, the user trust score 134 in FIG. 1. The per-user trust score indicates a level of trust, competence, experience, or prior success with performing self-checkouts of items accurately and correctly. In other words, the per-user trust score 404 indicates a degree of trust associated with permitting the user to scan items and checkout without assistance from store personnel.

The set of scoring criteria 132 is a set of one or more rules used to generate a per-basket verification score 136 by decrementing the per-user trust score 404 in accordance with the user's behavior while shopping and/or scanning items for self-checkout. In some examples, the set of scoring criteria 132 includes a predetermined decrement value applied to the per-user trust score 404 in response to occurrence of at least one trigger in the set of triggers 410. The set of triggers can include one or more triggers, such as, but not limited to, the triggers 122 in FIG. 1.

The set of triggers 410 is a set of behavior-related triggers identified by analyzing the first scan data 414 using the set of scoring criteria 132. The set of triggers 410 can include, without limitation, a threshold amount of time between scanning items, a threshold number of voided items, a threshold number of unknown items scanned, etc.

A voided item is an item scanned by the user and then deleted/canceled or otherwise removed from the set of scanned items/basket of items. A voided item can include a single item removed from a cart/basket or canceling all items in the entire basket.

An unknown item is an attempt to scan something that is not recognized as a valid barcode or other item identifier. In other words, an unknown item is a scan of an unreadable barcode or scan of an unrecognized barcode (barcode not in database).

The first scan data 414 is data generated by a scan device or user device utilized by a user while selecting items in the item selection area. The first scan data 414 can include, without limitation, the scan data 118 in FIG. 1, the scan data 208 in FIG. 2 and/or the first scan data 316 in FIG. 3. In some examples, the first scan data 414 identifies at least one item in the set of items scanned by the selected user, such as, but not limited to, the set of scanned items 220 in FIG. 2.

The per-basket verification score 136 in some examples is generated in response to the selected user reaching a basket completion checkpoint within the item selection area, such as, but not limited to, the basket completion checkpoint 212 in FIG. 2. The basket score generator 402 generates the per-basket verification score 136 using the set of scoring criteria 132.

In some examples, the basket score generator 402 decrements the per-user trust score 404 by a predetermined decrement amount in accordance with the set of scoring criteria 132 and the set of triggers 410 to generate the per-basket verification score 136 associated with a basket of items selected by the user, such as the basket 210 of item(s) 203 in FIG. 2 and/or the basket 210 of items in FIG. 3. The per-basket verification score 136 is a ranking or indicator of a trust value associated with one selected basket of items for self-check during a selected transaction. The per-basket verification score 136 can be represented using a number, symbol, percentage, or other score value.

For example, the per-basket verification score 136 can be a score on a scale from one to one-hundred where one-hundred is the highest score and one is the lowest score. In another example, the per-basket verification score 136 is a percentage score on a scale from fifty percent to one-hundred percent. In yet another non-limiting example, the per-basket verification score 136 is a score on a scale from one to ten, where ten is the highest score and one is the lowest score.

In one example, if the per-user trust score 404 is ten on a scale of one to ten, and there are two triggers present in the set of triggers, the per-user trust score is decremented by two points to generate a per-basket verification score of eight, where a score of ten is the highest score. In another example, if the per-user trust score is ninety on a scale of one to one-hundred and there a single trigger present in the set of triggers, the user trust score is decremented to generate a per-basket verification score of eighty-five.

In yet another non-limiting example, if there are no triggers detected, such as where the set of triggers 410 is a null set, the per-basket verification score 412 is equal to the per-user trust score 404. Thus, if the user trust score is eighty-eight percent on a scale of one percent to one-hundred percent and the set of triggers 410 is a null set, the per-basket verification score is also eighty-eight percent.

A basket approval component 416 approves transaction completion 419 associated with the basket of items without verification of contents of the basket if the per-basket verification score 136 is within an acceptable score threshold range 418. If the per-basket verification score 136 is outside the acceptable score threshold range 418, the self-check manager component 136 performs a partial verification of the contents of the basket prior to approving the contents of the basket.

A verification component in some examples compares a portion 421 of the first scan data 414 with second scan data 422 for partial verification 430 of the contents of the basket. The second scan data 422 includes data identifying a subset of items selected from the basket of items by the second user having an aggregate value within a threshold range. In some examples, the second scan data 422 identifies one or more items randomly selected from the basket of items.

The second scan data 422 can be obtained from one or more scan devices, such as, but not limited to, the scan device 116 in FIG. 1, the set of sensors 224 in FIG. 2 and/or the second scan device 320 in FIG. 3. The second scan data 422 is scan data generated by the second scan device scanning a threshold number of items 424 and/or a set of items having an aggregate value 426 within a threshold value range.

The verification component 420 approves transaction completion 428 based on the partial verification 430 of the contents of the user's basket if the one or more items identified by the second scan data 422 corresponds to the portion 421 of the items identified by the first scan data 414. If the item(s) identified by the second scan data 422 fails to match one or more items scanned by the user in the first scan data 414, a notification component 434 outputs a basket re-check notification 436 to a user device associated with a second user. The second scan data can fail to match items in the first scan data if the first user scanning the items while shopping to create the first scan data failed to correctly scan every item in the user's basket and/or scanned items not found in the user's basket.

The basket re-check notification instructs the second user to perform a comprehensive verification of the entire contents of the basket. The comprehensive verification involves manually scanning every item in the basket to generate third scan data. The transaction is completed using the third scan data. In other words, the third scan data is utilized to identify all the items in the basket and calculate a total purchase price for the items using the third scan data.

Thus, if the basket approval component 416 is unable to approve a transaction based on the per-basket verification score 136, the verification component can approve transaction completion 428 based on partial verification of a portion of the basket contents. If the partial verification fails, such as where at least one item identified in the second scan data fails to correspond to any item identified in the first scan data, the self-check manager component can reject or deny completion of the transaction until a comprehensive verification is performed to verify every item in the basket.

In some examples, each time the selected user performs a self-check operation, the self-check manager component 136 always begins with the same per-user trust score for the user. The per-user trust score is decremented based on the user's behavior during selection of items for each basket and/or transaction. Thus, the per-basket verification score 136 changes for each transaction but the per-user trust score 404 remains the same.

In still other examples, if the partial verification fails and a comprehensive verification is required to verify all the contents of the basket, the per-user trust score 404 is decremented to reflect the failure of the first user to scan all items in the user's basket correctly. Likewise, if the user successfully performs a self-check procedure with no behavior-based triggers or the number of triggers below a threshold value, the per-user trust score 404 can be incremented (increased) to reflect the user's demonstrated ability to accurately and correctly scan all or most items in the user's basket prior to arrival at the basket completion checkpoint.

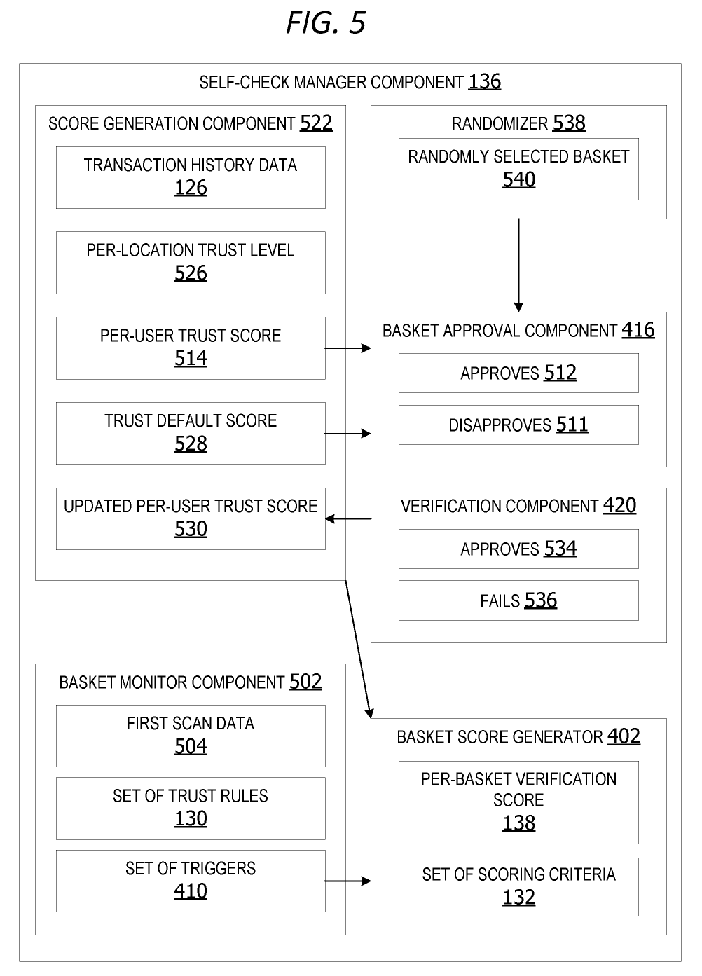

FIG. 5 is an exemplary block diagram illustrating a self-check manager component 136. A basket monitor component 502 analyzes first scan data 504 generated by a first scan device utilized by a selected user. The first scan data is analyzed using a set of trust rules 130 to identify a set of triggers 410. A trigger in the set of triggers can include at least one of a threshold number of voided items, a threshold number of unknown items scanned, and/or or a threshold idle time between scanning items associated with the first scan data.

If the set of triggers is a null set, the per-basket verification score is equal to the per-user trust score 514. Thus, the basket approval component 416 approves 512 a transaction associated with a basket of items selected from the plurality of items by the selected user without verification of contents of the basket on condition the set of triggers associated with the first scan data is a null set and the per-basket verification score 138 (equal to the user trust score 514) falls within an acceptable threshold score range. In other examples, the basket approval component 416 approves 512 the transaction if the set of triggers is a null set and the per-user trust score is greater than or equal to a threshold minimum trust score.

If the set of triggers includes at least one trigger, a basket score generator 402 generates the per-basket verification score based on the first scan data and a set of scoring criteria 132. The set of scoring criteria 132 includes a predetermined decrement value applied to the per-user trust score 514 in response to occurrence of at least one trigger.

A score generation component 522 generates the per-user trust score 514 for the selected user based on the transaction history data 126 associated with the selected user and a per-location trust level associated with the item selection area. In some examples, if the transaction history data for the selected user is unavailable or if there are no previous transactions associated with the user, the score generation component 522 assigns a default trust score value 528 to be used as the per-user trust score.

The score generation component 522 can generate an updated per-user trust score 530 for the selected user. In these examples, the score generation component 522 adjusts the per-user trust score downward indicating decreased trust if a threshold number of items identified in the second set of scan data fails to correspond to any item identified in the first scan data and/or a comprehensive verification reveals one or more items in the user's basket that were un-scanned by the user. The score generation component in other examples dynamically adjusts the per-user trust score assigned to the selected user upward indicating increased trust if the partial verification indicates that all items identified in the second scan data correspond to at least one item identified in the first scan data. In other examples, the score generation component generates an updated per-user trust score indicating an increased level of trust if a comprehensive verification of the user's basket indicates every item in the basket was identified in the first scan data/scanned by the first user.

The basket approval component 416 approves 512 the transaction without auditing items in the selected user's basket if the per-basket verification score for the basket is within an acceptable score threshold range. If the per-basket verification score is outside the acceptable score threshold range or below a minimum acceptable threshold score, in some examples, the basket approval component 416 disapproves 511 the completion of the transaction based on the first scan data 504 without a partial verification of the basket contents.

A verification component 532 in some examples performs the partial verification on a portion of the items in the selected user's basket. In some examples, the verification component audits a threshold number of items selected randomly from the selected user's basket. In other examples, the verification component 532 audits randomly selected items from the user's basket which have an aggregate value within a threshold value range.

For example, if the threshold number of items is three, the system analyzes second scan data identifying three items in the selected user's basket to determine if the three items match three of the items identified in the first scan data obtained from the scan device used by the selected user to scan the items in the selected user's basket.

In other examples, if the threshold aggregate value range is ten dollars, a second user randomly selects and scans items in the selected user's basket until the total aggregate value of the scanned items is equal to ten dollars or exceeds the ten-dollar minimum threshold aggregate value. When the aggregate value is equal to or greater than the minimum threshold value (within the value range), the second user stops scanning items in the selected user's basket.

The verification component 532 compares the first scan data 504 with the second scan data obtained from a second scan device to verify a subset of items from the basket. The second scan data can be obtained from one or more scan devices operating autonomously without human intervention. In other examples, the second scan data is obtained from a human user manually scanning items via a hand-held scan device or mounted scan device.

The verification component 532 approves 534 the self-check transaction associated with the basket of items without auditing the entire contents of the basket (verifying every item in the basket) if the subset of items identified in the second scan data corresponds to one or more items identified in a portion of the first scan data 504. If any item identified in the second scan data does not match at least one item in the first scan data, the verification component fails 536 the partial verification. If the partial verification fails, a comprehensive verification is performed.

A randomizer component 538 randomly selects a second basket associated with a third user for partial verification of content of the second basket. The basket approval component 416 disapproves completion of the transaction associated with the randomly selected basket 540 of the third user even if the set of triggers is a null set and a per-basket verification score for the basket is within the acceptable score threshold range. In other words, the randomly selected basket 540 is automatically subjected to a partial verification without generating a per-basket verification score.

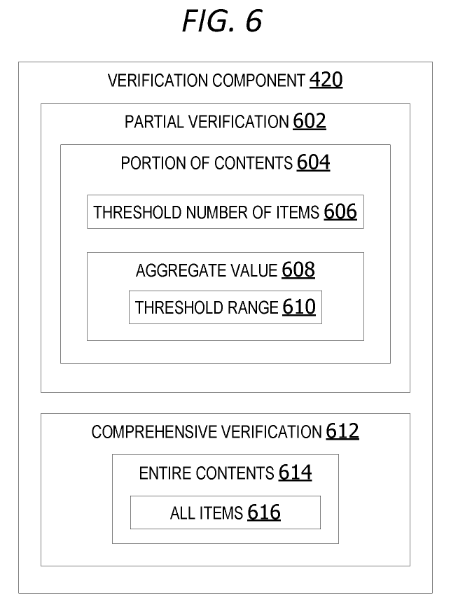

FIG. 6 is an exemplary block diagram illustrating a verification component 600. The verification component 600 performs a partial verification 602 on a portion of the contents 604 of a basket if the basket is randomly selected by the randomizer or the per-basket verification score is within an unacceptable threshold range (below a minimum score threshold value). The partial verification can be performed on a threshold number of items 606 randomly selected from the basket. The partial verification can also be performed on a subset of items having an aggregate value 608 that is within a threshold range 610.

For example, if the threshold number of items is two, the partial verification is performed using scan data associated with two items randomly selected from the basket. If the aggregate value 608 is twelve dollars, the partial verification is performed using scan data associated with one or more items randomly selected from the basket having an aggregate value of five dollars or more.

In one example, if the aggregate value 608 is fifteen dollars and a first item randomly selected from the basket has a value (price) of sixteen dollars, the partial verification is performed using a single item having the value of sixteen dollars. In another example, the aggregate value 608 is eight dollars and every item selected randomly from the basket has a value of one dollar, the partial verification is performed using the first eight items randomly removed from the basket.

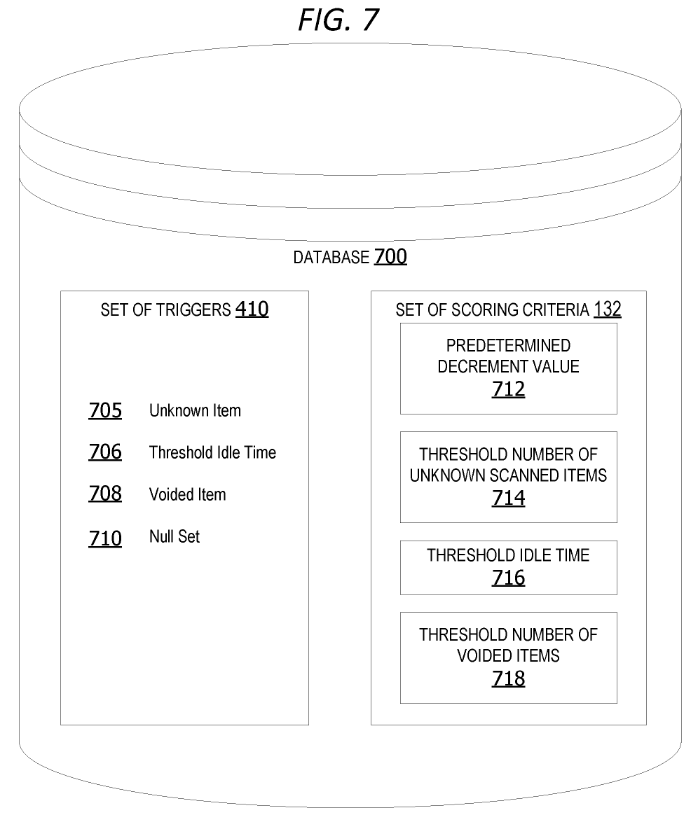

FIG. 7 is an exemplary block diagram illustrating a database 700. The database 700 is a structured set of data located on a data store, such as, but not limited to, the data storage device 124 in FIG. 1. In this example, the database 700 includes a set of triggers 410 and a set of scoring criteria 132. However, the examples are not limited to storing a set of triggers and a set of scoring criteria. In other examples, the database includes transaction history data, user trust score(s), or any other data.

The set of triggers 410 in this example includes an unknown item 705 scanned by the user and/or a first threshold idle time 706 between scanning two items or between scanning a last item and arriving at a basket completion checkpoint. If no behavior-related triggers are detected, the set of triggers 410 can be a null set 710.

The set of scoring criteria 132 in some examples include a predetermined decrement value 712 applied to the per-basket verification score in response to occurrence of a trigger. A trigger can include a threshold number of unknown scanned items 714, a second threshold idle time 716 and/or a threshold number of voided items 718 associated with the scan data generated by a scan device associated with the selected user. The threshold idle time 716 in some examples is a threshold amount of time between scanning of a first item and a second item. In other examples, the threshold idle time 716 is an amount of time between a first scan time associated with scanning a last item and a second scan time associated with scanning a basket completion code associated with the basket completion checkpoint. In some examples, the scan time is recorded/saved as a time stamp when an item or checkpoint code is scanned.

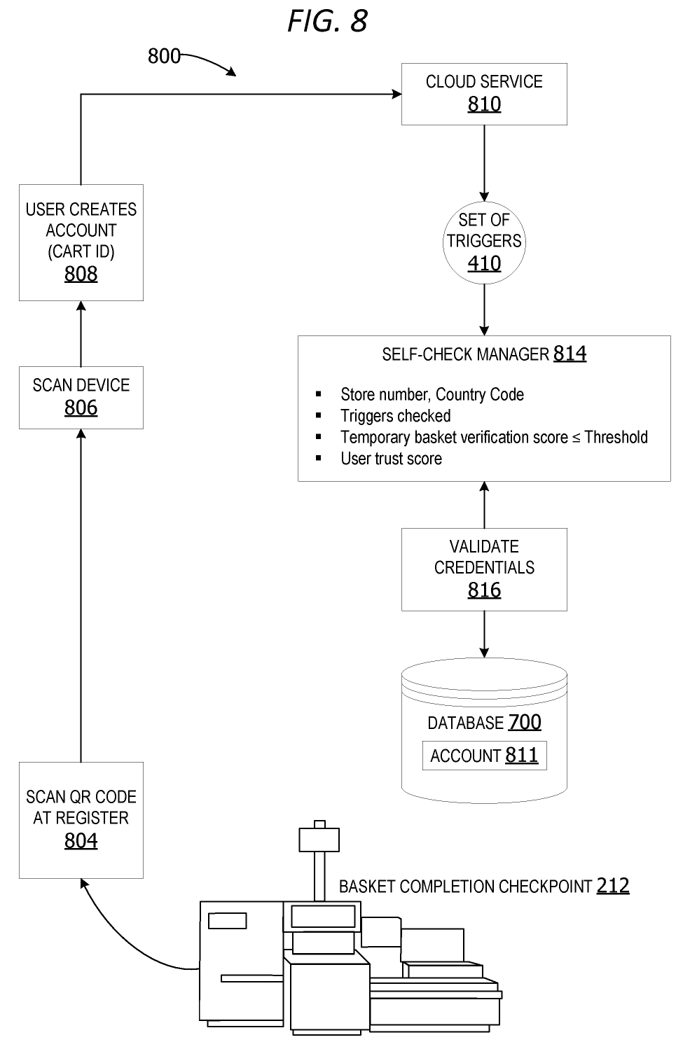

FIG. 8 is an exemplary block diagram illustrating a system 800 for score-based self-check basket auditing. When a user reaches a basket completion checkpoint 212, the user scans a QR code at the register 804 using a scan device 806. The scan device 806 can be a hand-held scan device or a user device, such as a mobile phone, tablet, or other portable computing device.

In some examples, the user utilizes an application on the user device to create an account 808. The account can include data, such as, but not limited to, a cart identifier (ID) identifying the user's basket of items. A cloud service 810 can optionally analyze the scan data generated by the scan device 806 with user provided data and/or data obtained from the user account 811. The cloud service 810 in this example includes a self-check manager which analyzes the scan data to identify the set of triggers 410. The set of triggers 410 can include the total number of items scanned and/or the number of items voided by the user.

The self-check manager can validate the user's credentials 816 using the account 811 data retrieved from a database 700. The database 700 is a data store, such as, but not limited to, the data storage device 124 in FIG. 1.

The self-check manager 814 analyzes the store number, country code, the set of triggers 410, and the user's account data to identify the user's trust score and generate a temporary basket verification score for the current self-check transaction. If the temporary basket verification score is less than or equal to a threshold value, the self-check manager authorizes the basket of items associated with the transaction without verification of the contents of the user's basket.

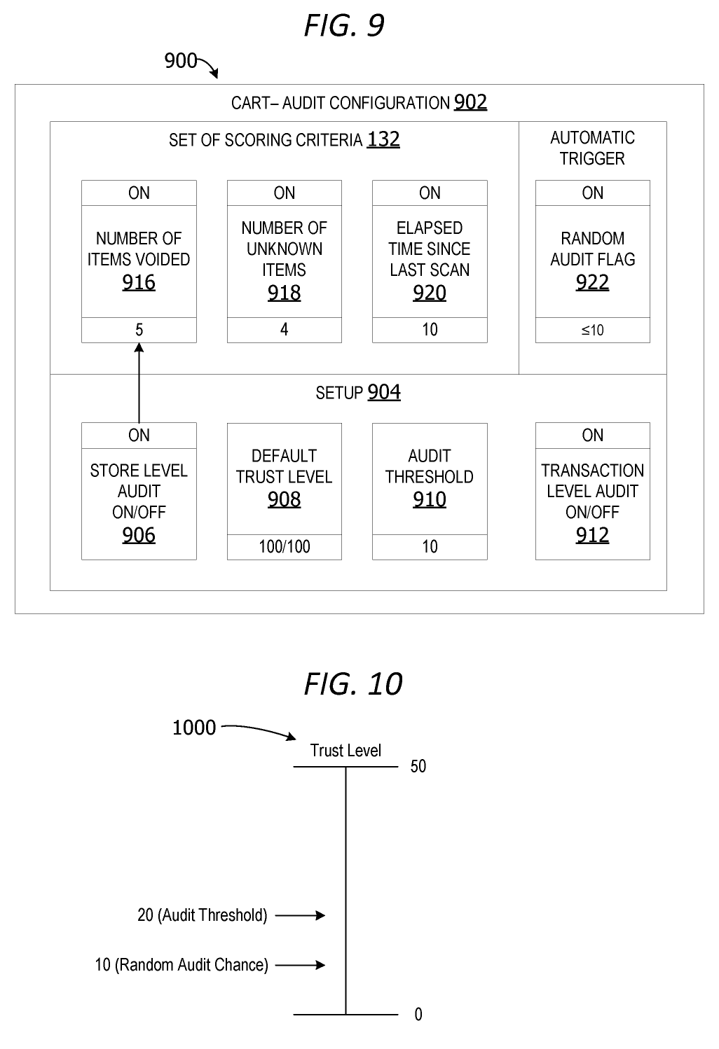

FIG. 9 is an exemplary block diagram illustrating an audit configuration file 900. The audit configuration file 900 optionally includes a cart-audit configuration 902 including a setup 904. The setup 904 can include a store level audit on or off control for activating or deactivating the self-check audit process at a store level. The audit configuration can also include a transaction level audit 912 on or off control for activating or deactivating the audit system at a transaction level.

A default trust level 908 is a default trust value assigned to a user without a previous user trust score and/or no prior transaction history. Thus, the first time a user utilizes the self-check audit system, the user can be assigned the default trust level. The audit threshold 910 is the threshold value at which a user's basket is audited. For example, if the audit threshold 910 is a value of twenty, the user's basket is audited if the user's trust score and/or the per-basket verification score is less than or equal to twenty.

The set of scoring criteria 132 can include the number of items voided 916, the number of unknown items 918 scanned, and/or the elapsed time since the last item was scanned 920. The set of scoring criteria 132 can include a decrement value applied to the per-basket verification score each time one of the triggers is detected. Each time the threshold number of items is voided, the decrement value is applied to the per-basket verification score. For example, if the threshold number of voided items is five, the per-basket verification score can be lowered by one point each time five items are voided by the user.

In other examples, each time the threshold number of items unknown items is scanned by the user, the decrement value is applied to the user's per-basket verification score. For example, if the threshold number of unknown items is four, the per-basket verification score is lowered by one point each time four unknown items are scanned by the user.

In still other examples, each time the threshold elapsed time since a last item was scanned transpires, the self-check manager decrements the user's per-basket verification score. For example, if the threshold elapsed time is twenty minutes, the per-basket verification score is lowered by one point each time a twenty-minute time period occurs in which the user fails to scan any items.

A randomizer component can apply a random audit flag 922 to a user's basket in some examples. The random audit flag 922 is an indicator for a randomly selected basket for partial verification regardless of the user's trust score, triggers, or the per-basket verification score.

FIG. 10 is an exemplary block diagram illustrating a range of per-basket verification scores. In this example, the range of possible scores is zero to fifty. The chance of randomly being selected for partial audit can be any user configurable percentage. In this non-limiting example, the chance a user will be randomly selected for partial audit verification is ten percent.

The audit threshold (minimum threshold score) can be any user-configurable threshold value. In this non-limiting example, the minimum threshold score is twenty. If the user's trust score or the per-basket verification score if twenty or lower, the user's basket is subject to partial verification. If the per-basket verification score is greater than or equal to twenty, the basket is approved without the partial verification or the comprehensive audit.

FIG. 11 is an exemplary flow chart illustrating operation of the computing device to verify contents of a basket based on first scan data and second scan data. The process shown in FIG. 11 can be performed by a customized returns manager component, executing on a computing device, such as the computing device 102.

The process begins by receiving basket completion code associated with a basket completion checkpoint at 1102. The basket completion code is a code which can be scanned by the user to trigger the self-check audit procedure, such as, but not limited to, the basket completion code 214 in FIG. 2. In some examples, the basket completion code is a QR code.

The self-check manager component determines if the basket is randomly selected for partial basket verification at 1104. If no, the self-check manager component obtains the first user's trust score at 1106. The trust score is a score generated based on the user's transaction history associated with the user's account, such as, but not limited to, the trust score 134 in FIG. 1.

The self-check manager component identifies a set of triggers in first scan data at 1108. The self-check manager component creates a basket verification score by decrementing the user's trust score based on the set of triggers and a set of scoring criteria at 1110. The self-check manager component determines if the basket verification score is within a threshold range at 1112. If yes, the self-check manager component approves completion of the transaction using the first scan data generated by the first scan device associated with the first user at 1114. The process terminates thereafter.

Returning to 1112, if the basket verification score is not within the threshold range, the self-check manager component verifies the basket contents using second scan data obtained from a second scan device at 1116. The process terminates thereafter.

In this non-limiting example, the self-check manager component generates the basket verification score after the user scans the basket completion code. In other examples, the self-check manager component generates the basket verification code dynamically as the user is scanning items and/or placing items in the user's basket. In these examples, the basket verification score is already created prior to the user scanning the basket completion code.

While the operations illustrated in FIG. 11 are performed by a computing device, aspects of the disclosure contemplate performance of the operations by other entities. For example, a cloud service can perform one or more of the operations.

FIG. 12 is an exemplary flow chart illustrating operation of the computing device to verify partial contents of a basket. The process shown in FIG. 12 can be performed by a customized returns manager component, executing on a computing device, such as the computing device 102.

The process beings by determining if the basket is randomly selected at 1202. If no, the self-check manager component determines if the per-basket verification score is acceptable at 1204. If no, the self-check manager component performs a partial verification of basket contents using the first scan data and second scan data at 1206. The self-check manager component determines if the partial verification is successful at 1208. If no, the self-check manager component performs a comprehensive verification of basket contents by analyzing third scan data at 1210. The third scan data is data generated by a second scan device, such as, but not limited to, the scan device 116 in FIG. 1, the set of sensors 224 in FIG. 2 and/or the second scan device 320 in FIG. 3. The self-check manager component completes the transaction at 1212. The process terminates thereafter.

Returning to 1204, if the per-basket verification score is acceptable, the self-check manager component completes the transaction at 1212 without a partial verification or comprehensive verification of the basket contents. The process terminates thereafter.

Returning to 1208, if the partial verification is successful, the self-check manager component completes the transaction at 1212 without a partial verification or comprehensive verification of the basket contents. The process terminates thereafter.

While the operations illustrated in FIG. 12 are performed by a computing device, aspects of the disclosure contemplate performance of the operations by other entities. For example, a cloud service can perform one or more of the operations.

FIG. 13 is an exemplary flow chart illustrating operation of the computing device to approve a basket without verification of basket contents. The process shown in FIG. 13 can be performed by a customized returns manager component, executing on a computing device, such as the computing device 102.

The process begins by generating a per-user trust score based on transaction history data of the user and a store trust level at 1302. The self-check manager component analyzes first scan data generated by a first scan device of the user using a set of trust rules at 1304. The self-check manager component identifies a set of triggers based on the analysis at 1306. The self-check manager component generates a per-basket verification score based on the per-user trust score, the set of triggers, and a set of scoring criteria at 1308. The self-check manager component compares a per-basket verification score with an acceptable score threshold range at 1310. The self-check manager component determines if the per-basket verification score is within an acceptable threshold range at 1312. If yes, the self-check manager component approves completion of the transaction without verification of the basket contents at 1314. The process terminates thereafter.

Returning to 1312, if the score is not within the acceptable threshold range, the self-check manager component rejects completion of the transaction without verification of at least a portion of the basket contents at 1316. The process terminates thereafter.

While the operations illustrated in FIG. 13 are performed by a computing device, aspects of the disclosure contemplate performance of the operations by other entities. For example, a cloud service can perform one or more of the operations.

FIG. 14 is an exemplary flow chart illustrating operation of the computing device to verify items in a basket based on basket scores. The process shown in FIG. 14 can be performed by a customized returns manager component, executing on a computing device, such as the computing device 102.

The process begins by generating a per-basket verification score based on a set of triggers and a user trust score at 1402. The self-check manager component determines if the set of triggers is a null set at 1404. If the set of triggers is a null set, the per-basket verification score is equal to the user's trust score. If the set of triggers is a null set, the self-check manager component approves transaction completion without verification of the basket contents at 1406. The process terminates thereafter.

Returning to 1404, if the set of triggers is not a null set, the self-check manager component determines if the per-basket verification score is within a threshold range at 1408. If yes, the self-check manager component approves transaction completion without verification of the basket contents at 1406. The process terminates thereafter.

Returning to 1408, if the score is within an acceptable threshold range, the self-check manager component obtains second scan data of a subset of items in the basket for partial verification at 1410. The self-check manager component compares the subset of items from the basket identified in the second scan data with items identified in the first scan data at 1412. The self-check manager component determines if the subset of items correspond with the items in the first scan data at 1414. If yes, the self-check manager component approves transaction completion at 1416. The process terminates thereafter.

Returning to 1414, if the subset of items fails to correspond to items in the first scan data, the self-check manager component disapproves completion of the transaction at 1418. The process terminates thereafter.

While the operations illustrated in FIG. 14 are performed by a computing device, aspects of the disclosure contemplate performance of the operations by other entities. For example, a cloud service can perform one or more of the operations.

FIG. 15 is an exemplary flow chart illustrating operation of the computing device to calculate a per-basket verification score. The process shown in FIG. 15 can be performed by a customized returns manager component, executing on a computing device, such as the computing device 102.

The process begins by obtaining a user trust score value at 1502. The self-check manager component determines if a trigger is met at 1504. A trigger is met if a threshold number of triggers occur, such as, but not limited to, a threshold number of voided items, a threshold number of unknown items scanned, and/or a threshold elapsed time. If yes, the self-check manager component lowers the value by a predetermined decrement value at 1506. The predetermined decrement value is any configurable value, such as, for example but not limited to, a single point, five points, ten points, or any other decrement value. The self-check manager component resets the trigger at 1508. Resetting the trigger enables the self-check manager component to detect the next trigger when it occurs as the user scans items into the user's basket.

The self-check manager component determines whether to continue at 1510. If yes, the self-check manager component iteratively executes operations 1502 through 1510 until a determination is made not to continue. In some examples, when a user scans a basket completion code, the self-check manager component determines not to continue. The self-check manager component assigns the decremented value to the per-basket verification score for the user's basket at 1512. The process terminates thereafter.

While the operations illustrated in FIG. 15 are performed by a computing device, aspects of the disclosure contemplate performance of the operations by other entities. For example, a cloud service can perform one or more of the operations.

### Additional Examples

Some examples provide a scan and go enterprise audit system. The system enables a user to perform a self-check procedure via a scan and go kiosk or via a scan and go hand-held scan device. The system obtains a customer account reference (cart ID) and customer trust level from a user account. When the user scans a basket completion checkpoint code, it triggers the system to retrieve the scan data from the user's scan device and the user's account data, including the user trust value and the user's account reference data.

In an example scenario, the audit service monitors customers as they shop and move around a store. Criteria are used to analyze the user's behavior to identify triggers indicating whether to perform partial verification of the user's basket contents. At a home office level (high level), the system correlates the user's transaction history with risk data via user account data provided during a user registration. The system obtains a risk level for a selected store/market/region (location) to determine whether there is greater risk of shrinkage or item loss due to store location, local events, seasonal influences, weather, local trends, etc. This data is utilized to determine whether to permit the user to self-check without additional verification of the basket contents by another human user (store personnel) or automated system (cameras, RFID tag readers, etc.). In this manner, the system minimizes risk of error or lost items when a customer utilizes a self-check to purchase items.

In an illustrative example, a user selects a hand-held scanner from a set of scanners available at a store. The user scans each item as they place the item in a cart or basket. When the user is done, the user goes to a POS and scans a single QR code (basket completion code). The self-check manager pushes notification as to whether the user is selected for partial verification based on random selection or based on the temporary basket verification score to the POS/register. If the user has not been selected, the user completes the check-out (pays) and returns the hand-held scanner.

In another example, the user gets into an express scanning lane. The user scans a QR code using a user device (phone). The self-check manager sends a notification to the POS/register indicating whether the user can check-out without verification or whether the user is selected for partial verification. The POS/register receiving the notification lights-up. The user proceeds to the appropriate POS/register (lit up). The user completes check-out.

In still another illustrative example, a user arrives at a store and picks up a hand-held scan device or uses a scanning application on their smart phone/tablet. The user scans a barcode on each item the user intends to purchase prior to placing the item in the user's cart/basket. When the user is finished shopping and is ready to leave/pay, the user goes to a checkout area (basket completion checkpoint) and scans a barcode on the checkout/POS device. The user cannot finish and pay while shopping in store in this example. The user scans the basket completion code to complete the checkout process. Scanning the barcode triggers the audit service/self-check manager component.

The self-check manager in another example maintains a record each item scanned by the user (contents of the basket) by obtaining the scan data from the user's scan device/smart phone as the user shops. The self-check manager updates the contents of the user's basket in real time as the user scans items and/or voids items. A record of the basket contents is maintained on the computing device/server hosting the self-check manager (home office level). When the user scans the basket completion code (QR code), the system transfers the record of the basket contents to the register POS device for completion of the transaction (payment). In other words, the self-check manager transfers the basket content record to the self-check POS device.

The self-check manager in other examples sends a lookup code to the POS device enabling the POS device to retrieve the record of the items scanned by the user. The POS device retrieves this data generated by the user's hand-held scan device or user device and concludes the transaction without performing a partial verification or comprehensive verification of the basket contents.

In another example, if the user is scanning items via an application on a user device, the application automatically sends the scan data to the self-check manager and/or the POS device as the user is scanning the items. In another example, when the user device scans the QR code (basket completion code), the application on the user device automatically transfers the first scan data (basket contents data) to the POS device.

In some examples, the system aggregates/combines store location data, the user's history data (prior purchases and returns) and trust score for the user. Service decides whether to trigger audit or let the user complete the self-check without audit based on analysis of the aggregated data. If a partial audit has been triggered based on the analysis, the system outputs/sends a notification to the user that a partial audit has been triggered. The user waits at the register until the automated system re-scans the items or an associate manually scans each of the items in the user's basket until a threshold is reached. The threshold can be a threshold number of items or a threshold dollar value of the items. The items can be scanned using a hand-held scanner or a mounted scanner.

In some examples, during a partial verification, random items are selected from the basket (associates choice) for re-scanning. When the threshold number of items has been scanned or the aggregate value of the rescanned items reaches a threshold value, the system compares the rescanned items to the items scanned by the user. If everything is accurate, the audit is terminated, and the self-checkout is completed. If there are any inaccuracies between the rescanned items and the items originally scanned by the user, a comprehensive audit is performed. The associate resumes scanning items in the basket until all items are rescanned. The self-check is completed using the rescanned item data to determine the amount due for payment by the user. The user is permitted to pay and go. The system can output a notification identifying any items scanned by the user which were not present in the user's basket as well as any items identified in the rescanned item data which were mistakenly not scanned by the user.

A cloud service in another example analyzes data elements, such as, but not limited to, the user's previous transaction history, store location, store history, regional data, the user's trust score, and the per-basket verification score. The cloud service sends a notification to a computing device at the store-level indicating whether to permit the user to complete the self-check without a partial verification or whether to perform the partial verification.

If a partial verification is triggered, in one example, a barcode displays on a hand-held device of the user. An associate scans the barcode on the user's hand-held device using a second hand-held device. The associate's scan device then takes over the check-out process.

Some users are randomly selected for partial verification of their basket contents even if there are no behavioral triggers or other red flags indicating a partial audit. In one example, the chance of being randomly selected for audit is ten percent. In other words, one in ten users are selected for audit. In another example, users can be selected for random audit at a rate of one percent, five percent, twelve percent, or any other user-defined rate.

The user's trust score value is adjusted down based on behavioral triggers. In one example, if the user's trust score is fifty and the user voids five items the score is reduced by 15 points, for a per-basket verification score of thirty-five. If the user voids five more items, the system lowers the per-basket verification score to twenty. In this example, if the threshold score is twenty-five, the user is selected for partial verification of the basket contents based on the per-basket verification score.

In another example, if the user's trust score is thirty-five and the user scans four unknown items, the base per-basket verification score (temporary score) is decremented by 10 points, for a final score of twenty-five. If the minimum threshold score is twenty, the user's basket is not selected for partial verification of the baskets contents based on the user's basket verification score.

If a user is selected for partial audit or comprehensive audit a threshold number of times, the user's trust score is decremented downward to reflect the number of basket verifications (number of triggers). In another example, if the user is only selected for audit randomly and maintains a consistently acceptable basket score for a threshold number of check-out transactions, the user's trust score is increased upward to reflect the consistently good history over time. The user can be disqualified from the self-check program is the user's trust score falls below a minimum qualification score threshold.

The scan device utilized by the user in some examples maintains a virtual basket of the scanned items. The user scans a QR code or other basket completion code at a check-out area to transfer the virtual basket of items to the register. The user pays at the register and goes. If the user is selected for partial verification audit based on random selection or the basket verification score, the scan device outputs a notification to the user.

An automated scanning system (set of sensors/image capture devices) auto-scans some/all of the items in the user's physical basket to determine if they match up with the items scanned by the user (customer). The system identifies missed items not scanned by user, mis-scanned items, mis-identified items, and items scanned which are not physically present in the basket.

If the auto-scan system cannot automatically identify one or more items in the basket via image analysis or other sensor data due to an obstruction, such as an item covered by another item or other object blocking the camera view, the system sends a notification to a user device associated with a second user (associate). The notification instructs the second user to assist with scanning items in the cart/basket for the partial verification and/or the comprehensive verification audit.

Alternatively, or in addition to the other examples described herein, examples include any combination of the following:
a score generation component, implemented on the at least one processor, that generates the per-user trust score associated with the first user based on transaction history data associated with the first user and a store trust level associated with the item selection area;
a default trust score value, wherein the per-user trust score is assigned the default trust score value on condition the transaction history data associated with the first user is unavailable;
wherein the set of triggers further comprises a set of unknown scanned items, wherein the set of scoring criteria comprises a predetermined score decrement value applied to the per-basket verification score in response to occurrence of a threshold number of unknown scanned items associated with the first scan data;
wherein the set of triggers further comprises a set of unknown scanned items;
wherein the set of scoring criteria comprises a predetermined score decrement value applied to the per-basket verification score in response to occurrence of a threshold number of unknown scanned items associated with the first scan data;
wherein the set of triggers further comprises an idle time between scanning of a first item and a second item or an idle time between scanning a last item and basket completion checkpoint arrival time;
wherein the set of scoring criteria comprises a predetermined score decrement value applied to the per-basket verification score in response to occurrence of a threshold idle time between the last item scan time and the basket completion checkpoint arrival time;
a randomizer component, implemented on the at least one processor, that randomly selects a second basket associated with a third user for partial verification of content of the second basket;
wherein the basket approval component disapproves completion of a transaction associated with the basket of the third user having a per-basket verification score within the acceptable score threshold range if the second basket is randomly selected by the randomizer component;
a score generation component, implemented on the at least one processor, that adjusts the per-user trust score associated with the first user downward indicating decreased trust on condition a threshold number of items identified in the second set of scan data fails to correspond to any item identified in the first scan data;
a score generation component, implemented on the at least one processor, that adjusts the per-user trust score associated with the first user upward indicating increased trust on condition all items identified in the second scan data correspond to at least one item identified in the first scan data;
reducing, by a basket score generator, the per-user trust score by a predetermined decrement value in response to detecting attempted scanning of a threshold number of unknown items in the set of unknown scanned items to generate a per-basket verification score associated with a basket of items selected by the selected user;
wherein the set of triggers further comprises a set of voided items associated with the first scan data;
decrementing the per-basket verification score by a predetermined value on condition the detected set of voided items includes a threshold number of voided items;
the set of triggers further comprises an idle time between scanning a first item and scanning a second item;
decrementing the per-basket verification score by a predetermined value on condition the idle time exceeds a threshold idle time;
wherein the set of triggers further comprises an idle time between scanning a last item and scanning a basket completion checkpoint identifier;
decrementing the per-basket verification score by a predetermined value on condition the idle time exceeds a threshold idle time;
reducing the per-user trust score associated with the selected user to generate an updated per-user trust score for the selected user on condition a threshold number of items identified in the second set of scan data fails to correspond to at least one item identified in the first scan data;
a notification component, implemented on the at least one processor, that outputs a basket re-check notification requesting verification of the entire contents of the basket by the second user prior to completion of the transaction on condition a set of items identified in the second scan data fails to correspond to any item identified in the first scan data;
a basket completion code associated with the basket completion checkpoint, wherein the basket approval component retrieves the first scan data in response to the first scan device scanning the basket completion code;
a score generation component, implemented on the at least one processor, that adjusts the per-user trust score associated with the first user downward on condition a threshold number of items identified in the second set of scan data fails to correspond to any item identified in the first scan data; and
a score generation component, implemented on the at least one processor, that adjusts the per-user trust score associated with the first user upward indicating increased trust on condition all items identified in the second scan data correspond to at least one item identified in the first scan data.

At least a portion of the functionality of the various elements in FIG. 1, FIG. 2, FIG. 3, FIG. 4, FIG. 5, FIG. 6, FIG. 7, FIG. 8, FIG. 9 and FIG. 10 can be performed by other elements in FIG. 1, FIG. 2, FIG. 3, FIG. 4, FIG. 5, FIG. 6, FIG. 7, FIG. 8, FIG. 9 and FIG. 10, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9 and FIG. 10.

In some examples, the operations illustrated in FIG. 11, FIG. 12, FIG. 13, FIG.14 and FIG. 15 are implemented as software instructions encoded on a computer readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for a score-based self-check audit system. For example, the elements illustrated FIG. 1, FIG. 2, FIG. 3, FIG. 4, FIG. 5, FIG. 6, FIG. 7, FIG. 8, FIG. 9 and FIG. 10, such as when encoded to perform the operations illustrated in FIG. 11, FIG. 12, FIG. 13, FIG. 14 and FIG. 15, constitute exemplary means for generating a per-user trust score based on transaction history data associated with a selected user and a store trust level associated with an item selection area; exemplary means for first scan data obtained from a first scan device associated with the selected user using a set of trust rules; exemplary means for identifying a set of triggers, including a set of unknown scanned items associated with the first scan data; exemplary means for generating a per-basket verification score based on the per-user trust score, the set of triggers, and a set of scoring criteria; exemplary means for approving completion of a transaction associated with a basket of items selected from a plurality of items by the selected user without verification of contents of the basket on condition the set of triggers associated with the first scan data is a null set or the per-basket verification score is within an acceptable score threshold range; exemplary means for approving completion of the transaction without verification of an entire contents of the basket on condition a subset of items from the basket of items identified by second scan data obtained from a second scan device corresponds to at least one item identified by the first scan data; and exemplary means for rejecting completion of the transaction on condition at least one item identified in the second scan data fails to correspond to any item identified in the first scan data.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized trust-based basket verification, the system comprising:
a memory;
at least one processor communicatively coupled to the memory;
a first scan device generating first scan data associated with a set of scanned items in a plurality of items within an item selection area;
a basket score generator, implemented on the at least one processor, that decrements a per-user trust score associated with a first user in accordance with a set of scoring criteria and a set of triggers within the first scan data to generate a per-basket verification score associated with a basket of items selected by the first user in response to the first user reaching a basket completion checkpoint within the item selection area, the first scan data identifying at least one item in the set of scanned items, the set of scoring criteria comprising a predetermined decrement value applied to the per-user trust score in response to occurrence of at least one trigger;
a basket approval component, implemented on the at least one processor, that approves the basket of items without verification of contents of the basket on condition the per-basket verification score is within an acceptable score threshold range;
a verification component, implemented on the at least one processor, that compares the first scan data with second scan data obtained from a second scan device associated with a partial verification of the contents of the basket and approves the basket of items with the partial verification of the contents of the basket on condition the second scan data corresponds to at least a portion of the first scan data, the second scan data comprising data identifying a threshold number of items from the basket of items; and
a notification component, implemented on the at least one processor, that outputs a basket re-check notification requesting a comprehensive verification of the contents of the basket by a second user prior to approval of the basket on condition an item identified in the second scan data fails to correspond to an item identified in the first scan data.

2. The system of claim 1, further comprising:
a score generation component, implemented on the at least one processor, that generates the per-user trust score associated with the first user based on transaction history data associated with the first user and a per-location trust level associated with the item selection area.

3. The system of claim 2, further comprising:
a default trust score value, wherein the per-user trust score is assigned the default trust score value on condition the transaction history data associated with the first user is unavailable.

4. The system of claim 1, wherein the set of triggers further comprises a set of unknown scanned items, wherein the set of scoring criteria comprises the predetermined decrement value applied to the per-basket verification score in response to occurrence of a threshold number of unknown scanned items associated with the first scan data.

5. The system of claim 1, wherein the set of triggers further comprises an idle time between scanning of a first item and a second item, wherein the set of scoring criteria comprises the predetermined decrement value applied to the per-basket verification score in response to occurrence of a threshold idle time between the first item scan time and the second item scan time.

6. The system of claim 1, wherein the set of triggers further comprises an idle time between scanning a last item and basket completion checkpoint arrival time, wherein the set of scoring criteria comprises the predetermined decrement value applied to the per-basket verification score in response to occurrence of a threshold idle time between the last item scan time and the basket completion checkpoint arrival time.

7. The system of claim 1, further comprising:
a randomizer component, implemented on the at least one processor, that randomly selects a second basket associated with a third user for the partial verification of the contents of the second basket, wherein the basket approval component disapproves completion of a transaction associated with the basket of the third user having the per-basket verification score within the acceptable score threshold range if the second basket is randomly selected by the randomizer component.

8. The system of claim 1, further comprising:
a score generation component, implemented on the at least one processor, that adjusts the per-user trust score associated with the first user downward indicating decreased trust on condition the threshold number of items identified in the second scan data fails to correspond to any item identified in the first scan data.

9. The system of claim 1, further comprising:
a score generation component, implemented on the at least one processor, that adjusts the per-user trust score associated with the first user upward indicating increased trust on condition all items identified in the second scan data correspond to at least one item identified in the first scan data.

10. A computer-implemented method for customized trust-based basket verification, the computer-implemented method comprising:
generating, by a score generation component, a per-user trust score based on transaction history data associated with a selected user and a per-location trust level associated with an item selection area;
analyzing, by a basket monitor component, first scan data obtained from a first scan device associated with the selected user using a set of trust rules to identify a set of triggers, the set of triggers comprising a set of unknown scanned items associated with the first scan data;
generating, by a basket score generator, a per-basket verification score based on the per-user trust score, the set of triggers, and a set of scoring criteria;
approving, by a basket approval component, a basket of items selected from a plurality of items by the selected user without verification of contents of the basket on condition the set of triggers associated with the first scan data is a null set or the per-basket verification score is within an acceptable score threshold range;
approving, by a verification component, the basket of items with partial verification of a portion of the contents of the basket on condition a subset of items from the basket of items identified by second scan data obtained from a second scan device corresponds to at least one item identified by the first scan data, the second scan data comprising data identifying a threshold number of items from the basket associated with the selected user; and
rejecting the basket of items on condition at least one item identified in the second scan data fails to correspond to any item identified in the first scan data.

11. The computer-implemented method of claim 10, further comprising:
reducing, by the basket score generator, the per-user trust score by a predetermined decrement value in response to detecting attempted scanning of a threshold number of unknown items in the set of unknown scanned items to generate the per-basket verification score associated with the basket of items selected by the selected user.

12. The computer-implemented method of claim 10, wherein the set of triggers further comprises a set of voided items associated with the first scan data, and further comprising:
decrementing the per-basket verification score by a predetermined value on condition the detected set of voided items includes a threshold number of voided items.

13. The computer-implemented method of claim 10, wherein the set of triggers further comprises an idle time between scanning a first item and scanning a second item, and further comprising:
decrementing the per-basket verification score by a predetermined value on condition the idle time exceeds a threshold idle time.

14. The computer-implemented method of claim 10, wherein the set of triggers further comprises an idle time between scanning a last item and scanning a basket completion checkpoint identifier, and further comprising:
decrementing the per-basket verification score by a predetermined value on condition the idle time exceeds a threshold idle time.

15. The computer-implemented method of claim 10, further comprising:
reducing the per-user trust score associated with the selected user to generate an updated per-user trust score for the selected user on condition the threshold number of items identified in the second scan data fails to correspond to at least one item identified in the first scan data.

16. A system for customized score-based basket verification, the system comprising:
a memory;
at least one processor communicatively coupled to the memory;
a first scan device associated with a first user within an item selection area, the item selection area comprising a plurality of items;
a basket monitor component, implemented on the at least one processor, that analyzes first scan data obtained from the first scan device using a set of trust rules to identify a set of triggers upon arrival of the first user at a basket completion checkpoint, a trigger in the set of triggers comprising at least one of a threshold number of voided items, a threshold number of unknown items scanned, or a threshold idle time between scanning items associated with the first scan data;
a basket approval component, implemented on the at least one processor, that approves a basket of items selected from the plurality of items by the first user without verification of contents of the basket on condition the set of triggers associated with the first scan data is a null set;
a basket score generator, implemented on the at least one processor, that generates a per-basket verification score based on the first scan data and a set of scoring criteria on condition the set of triggers comprise at least one trigger, the set of scoring criteria comprising a predetermined decrement value applied to a per-user trust score in response to occurrence of the at least one trigger;
the basket approval component, implemented on the at least one processor, that approves the contents of the basket on condition the per-basket verification score is within an acceptable score threshold range;
a verification component, implemented on the at least one processor, that compares the first scan data with second scan data obtained from a second scan device associated with a second user verifying a subset of items from the basket; and
the verification component, implemented on the at least one processor, that approves the basket of items without a comprehensive verification of every item in the basket on condition the second scan data corresponds to at least a portion of the first scan data, the second scan data comprising data identifying the subset of items selected from the basket of items by the second user having an aggregate value within a threshold range.

17. The system of claim 16, further comprising:
a notification component, implemented on the at least one processor, that outputs a basket re-check notification requesting verification of the contents of the basket by the second user prior to completion of a transaction on condition a set of items identified in the second scan data fails to correspond to any item identified in the first scan data.

18. The system of claim 16, further comprising:
a basket completion code associated with the basket completion checkpoint, wherein the basket approval component retrieves the first scan data in response to the first scan device scanning the basket completion code.

19. The system of claim 16, further comprising:
a score generation component, implemented on the at least one processor, that adjusts the per-user trust score associated with the first user downward on condition a threshold number of items identified in the second scan data fails to correspond to any item identified in the first scan data.

20. The system of claim 16, further comprising:
a score generation component, implemented on the at least one processor, that adjusts the per-user trust score associated with the first user upward indicating increased trust on condition all items identified in the second scan data correspond to at least one item identified in the first scan data.
